(19) United States
(12) Patent Application Publication
(10) Pub. No.: US 2013/0046621 A1
(43) Pub. Date: Feb. 21, 2013

(54) METHOD AND SYSTEM FOR INCENTING OFFLINE SALES WITH ONLINE ADVERTISING

(71) Applicants: David Asseoff, Greenwood Village, CO (US); Matthew Lord, Denver, CO (US); Peter Vogel, Denver, CO (US)

(72) Inventors: David Asseoff, Greenwood Village, CO (US); Matthew Lord, Denver, CO (US); Peter Vogel, Denver, CO (US)

(73) Assignee: Plink, Inc., Denver, CO (US)

(21) Appl. No.: 13/587,026

(22) Filed: Aug. 16, 2012

Related U.S. Application Data
(60) Provisional application No. 61/524,098, filed on Aug. 16, 2011.

(51) Int. Cl. G06Q 30/02

(52) U.S. Cl. 705/14.51

(57) ABSTRACT

A method of advertising on a communication network, includes the use of computational equipment for receiving a network request from a user, transmitting via a network advertising data for presenting an advertisement to the user, receiving a first transmission indicative of a user responding to such advertisement and storing information relating to the user's response. A second transmission is received indicative of a purchase of the item by a user where payment for such purchase is identified by a transaction card. The data for the second transmission is obtained from a data storage that includes data indicative of purchases by a plurality of users at a plurality of merchants, and such data is used to determine that a purchase occurred at a location where a user traveled for such purchase. A reward is generated corresponding to the user responding to the advertisement.

### RELATED APPLICATION

This application claims priority from U.S. Provisional Patent Application Ser. No. 61/524,098 on Aug. 16, 2011. The entire disclosure of the prior application is considered to be part of the disclosure of the accompanying application and is hereby incorporated by reference.

### BACKGROUND

Incentive Based Marketing

An incentive based marketing program is based on the assumption that when consumers are provided with an incentive to perform a particular action (e.g., visit a website, purchase a product, sign up for an email distribution, etc.) such consumers are more likely to the particular action. Common incentives used include providing consumers with coupons, discounts, mail-in rebates, etc. Of course, any incentive based marketing program is dependent on the viability and desirability of the incentive.

Explosive Growth of Virtual Currency

Social media and Facebook in particular, continue to explode as a worldwide phenomenon. As of May 1, 2011, Facebook's worldwide membership stands at over 680 million with more than 100,000,000 new members in the last 5 months. Growth has continued at a rapid rate; US total membership in Facebook is currently above 155 million—over 50% larger than it was in January 2010, just 16 months earlier.

Survey results show that nearly 25% of Facebook users play social games making it the largest portal to social games. Estimates place the total number of social game players, both Facebook members and others, above 300 million according to an Info Solutions Group/Pop Cap study (www.infosolutionsgroup.com). Gaming on Facebook has propelled the growth of the network. Cityville grew to a size of 26 million users in just 12 days and in January, 2011 surpassed 90 Million, in just 43 days—the fastest growing game in history. Moreover, there are over 200 other games that average over one million monthly users each.

Virtual currencies of all types have quickly established themselves as vehicles of commerce, wherein the term “virtual currency” (and variations thereof) refers to any currency having only an electronic form that is only capable of purchasing virtual products or service within one or more online communities, including social networking website, virtual worlds, and online gaming sites. Currently, a $2 billion (U.S. dollars) market and quickly growing, virtual currencies have become omni-present in the social game market and are quickly penetrating mainstream markets. Slightly more than half (53%) of social garners say they've earned and/or spent virtual currency in a social game, while 28% have purchased virtual currency with real-world money. It is anticipated that large multi-game currencies will be accepted and utilized across multiple venues are the future.

Most social games engage users and earn revenue through a robust virtual currency and virtual good economy. Users earn virtual currency by playing the game and completing tasks. This currency is a measure of “winning” in the game. Virtual currency is often awarded to indicate when a user achieves a new level. It is also used for comparison, so that users can evaluate their performance in the game by comparing point totals on leader boards. Virtual currency is the measure of status and wealth, and many games are complete with massive catalogs of virtual goods for purchase, including premium and limited edition virtual goods that often serve little function in terms of actual game play but provide personalization and a measure prestige for garners.

Currently the social network, Facebook, seems to be the best positioned to become the defacto currency with their Facebook Credits being a dominant virtual currency. On Jul. 1, 2011 all games using Facebook as a portal must accept Facebook Credits. This move will quickly establish the Facebook Credits brand in the minds of both social garners and Facebook users in general. Facebook is also making in-roads into more traditional types of commerce with virtual currency in areas such as: film rentals, events (e.g., concert ticket sales), and the sales of third party products/services via the Facebook Market.

Facebook Credits is a form of virtual currency that Facebook will require game developers to accept as a universal currency as of Jul. 1, 2011. As a universal currency, Facebook Credits is anticipated to quickly achieve status and mass appeal because it has value across many games. Facebook has stated that it aims to take its virtual currency even further by allowing consumers to use Facebook Credits for goods outside of the games.

The virtual currency market is too big, both domestically and internationally, to be ignored by other major Internet enterprises such as Google, Apple, PayPal, etc. Accordingly, it is expected that such major Internet enterprises will also offer products/services transactions utilizing one or more virtual currencies. It would be desirable to utilize virtual concurrencies in online (Internet) incentive based marketing programs, wherein amounts in such virtual concurrencies can be utilized as incentives in the incentive based marketing programs.

Pay-for-Performance Marketing

In order to be successful, businesses must drive incremental sales, traffic and loyalty, and want to do so with a degree of confidence in their return on investment (ROI). Current online advertising models for offline merchants lack any substantial direct accountability. What is needed is an extremely low-risk but effective marketing/advertising method and system, wherein if the utilization of such a method and system does not drive increased sales for a business, then the business does not pay for it.

Pay-for-performance advertising provides compensation to an advertiser only when one or more predetermined actions are performed by a consumer viewing a pay-for-performance advertisement. Such actions may be clicking on the advertisement, purchasing a product/service presented in the advertisement, downloading a particular Internet/software application, the consumer setting his/her default home to a predetermined website, etc. Over the past several years pay-for-performance advertising (In-game, Affiliate and Search pay-for-performance) has become the largest online advertising technique, with spending therefor growing from nearly $13.4 billion in 2009 to 16.2 billion in 2010, which a 21% increase.

Accordingly, it would be desirable to have a pay-for-performance marketing method and system that also utilizes virtual concurrencies in online (Internet) incentive based marketing programs, wherein amounts in such virtual concurrencies can be utilized as incentives in the incentive based marketing programs.

Online-to-Offline (O2O) Marketing/Advertising Programs

When it comes to Online-to-Offline (O2O) marketing/advertising programs, such programs are generally based on coupons or other advertising techniques that are not easily tracked, and generally well recognized as having a very low consumer response rate. Accordingly, it would be advantageous to utilize an O2O marketing/advertising method and system that is far more effective than prior art methods and systems. Moreover, it would be advantageous to advantageous to provide an O2O marketing/advertising method and system utilizing incentive-based marketing, virtual currencies, and pay-for-performance advertising methods to drive the millions of on-line social garners into retail establishments in a cost effective and profitable manner.

Accordingly, it would be desirable to have an Online-to-Offline (O2O) marketing program designed to use incentive-based marketing and pay-for-performance advertising methods to drive the millions of consumers that access Facebook (or other social network websites) and/or access on-line social games to physically travel to retail establishments that are advertized online, and do so in a cost effective and profitable manner. In particular, it would be desirable to offer retailers a measurable advertising method and system for turning Facebook and social game users into frequent, loyal and profitable retail customers. The above features for a more desirable or advantageous advertising/marketing system as recited above is believed to be satisfied by the advertising system and method disclosed hereinbelow.

### SUMMARY

The present disclosure describes an advertising system and method (herein also denoted “Plink” or the “Plink advertising system”) wherein online (Internet) to offline sales are fostered and enhanced by utilizing incentive-based marketing, virtual currencies, and pay-for-performance advertising methods. In particular, when both consumers and merchants register with Plink, and Plink presents merchant member online advertising to the consumer members, upon the Plink consumer members physically traveling to the merchant members location and purchasing an online Plink advertised product or service (an “item” hereinbelow), Plink provides such consumer members with rewards. The rewards may be related to online (Internet) activities, and in particular, such rewards may include amounts of virtual currencies. Furthermore, an entity operating the Plink system and method may receive compensation dependent on the revenues merchant members receive from Plink consumer members that, e.g., purchase an online advertised item(s) at Plink merchant members' actual physical store locations.

Providing virtual currencies as rewards to Plink consumer members is an important feature of the present disclosure in that such virtual currency rewards may result in efficiencies since there may be reduced or no transaction fees (as can be incurred with credit or debit card charges) for purchasing products or services with such virtual currencies. Also, since the virtual currencies may be purchased in bulk at reduced rates from issuer's, using virtual currency for consumer rewards may allow the operators of Plink and/or its merchant members to provide larger rewards to consumer members than consumer members would expect. Moreover, the Plink advertising system disclosed herein provides for exchanging between virtual currencies and/or allowing consumer members to determine customized allocations among a plurality of virtual currencies.

For registering consumer members, a consumer contacts a Plink website and provides a login identity and password (or other authentication) as well as: (i) his/her actual name, (ii) physical address (including zip code), (iii) email address, and (iv) information identifying one or more of his/her credit or debit cards (collectively referred to herein as “transaction cards”) that allow transactions on such cards to be programmatically extracted and transmitted to Plink, wherein such transaction card information includes: the type of card (debit or credit), issuer of the card (e.g., American Express), name of the person/entity to whom the card is issued, and login credentials for the online banking or credit account (or any other information necessary for identifying the card). Note that in one embodiment, to provide more security against unauthorized use of consumer member transaction cards, consumers do not provide their transaction card specific identification (e.g., credit/debit card identification numbers) to Plink since the information of (i) through (iv) above may be sufficient for capturing a consumer member's use of his/her transaction card(s) at merchant members.

Moreover, it is an important aspect of the Plink advertising system that during registration of each consumer member, the consumer member must provide permission for the tracking of the consumer member's purchases, and such permission may be restricted in some cases to purchases made at specific merchant members, e.g., merchant members designated or identified by the consumer member. Additionally, during registration, the consumer may also enter information identifying member merchants that the consumer has or would have an interest in travelling to their stores and purchasing items therefrom. Note that a consumer may be offered an opportunity to register with Plink when a consumer clicks on an online advertisement presented by Plink.

Accordingly, once a consumer member registration has been completed resulting in a new consumer member, and Plink presented online advertising is activated (e.g., clicked or otherwise selected) by the consumer member, then corresponding advertising activation information is received by Plink and associated with the consumer member. Subsequently, when the consumer member purchases an item from a merchant member, information about the purchase is transmitted (e.g., via a network such as the Internet) to Plink for determining whether the purchase corresponds to an item that was advertised to the consumer member via Plink. In particular, Plink uses such purchase related information to determine, e.g., the consumer member's identity, the merchant member's identity, and information identifying the purchase so that Plink can determine if the purchase qualifies the consumer member for a reward. Said another way, once such a purchase is made by a consumer member, online rewards may be provided to the consumer, including, e.g., rewards in a virtual currency of the consumer member's choice, such as a virtual currency from a social network (e.g., Facebook), a game website, and/or another entertainment website such as a movie presentation website. Plink may also offer its own virtual currency that may be redeemable into the specific currencies that various websites accept. Thus, in one Plink embodiment, a consumer member may be able to convert part of his/her Plink currency into Facebook currency, another part into currency acceptable by www.hulu.com or a game website such as www.playdom.com.

In one embodiment, Plink may receive information about purchases of consumer members (at merchant member locations) by accessing transaction card purchase information stored by transaction card issuing or transaction card processing entities, wherein only such purchase information about consumer member purchases are obtained. In particular, such consumer member purchase information is obtained by Plink without Plink (or an representative thereof) communicating with a merchant member, and without Plink (or an representative thereof) communicating with a point-of-sale device (e.g., at a merchant member's store).

In at least one embodiment, it is an aspect of Plink to monitor consumer member shopping patterns, as well as invoice Plink merchant members for an agreed upon percentage (e.g., 10-25%) of each consumer member purchase derived from Plink advertising.

Thus, in at least one embodiment, Plink: (i) enables simple and seamless retail transactions at merchant member physical locations to which consumer members travel, (ii) provides measurable and track able results, and (iii) results in Plink having loyal and frequent consumers return to the website(s) upon which Plink advertises. Accordingly, this, in turn, may also drive additional traffic to the Plink website(s), e.g., to access additional Plink advertising. Thus, Plink obtains revenue streams both from consumer member purchases at merchant member stores, and from driving consumer member return traffic to its website(s) having Plink advertising.

In particular, the ad tracking system of the present Plink disclosure reaches consumers while they are online, builds merchant member brand awareness and then rewards consumer members with various types of currency and/or rewards in response to purchases that can be verifiably tracked to online advertising presented via the Plink website(s) or affiliate websites. Moreover, since consumer member transactions at Plink merchant members are tracked through identifying the payment by the consumer members for such transactions, via their credit or debit cards (collectively referred to herein as “transaction cards”), the consumer retail experience is unencumbered by additional complexity for both the consumer member and the merchant member's personnel. Thus, the Plink advertising system and method disclosed herein provides for simple and seamless transactions with no paperwork, no training, and no point-of-sale (POS) integration for the merchant members. Moreover, when a consumer member registers a transaction card with Plink, Plink may receive between one and several months of the consumer member's past transaction history (prior to Plink registration). Such pre-Plink registration transaction card usage data can be used to provide merchant members with historical data of consumer members' purchasing patterns prior to the Plink registration of such transaction cards. Accordingly, an embodiment of the Plink advertising system may perform statistical analysis of the differences and similarities in consumer member behavior between pre and post Plink shopping patterns. Statistics resulting from comparison/analysis of such pre and post Plink registration may be used as another metric for verifying the efficacy of the Plink advertising.

Since, in one embodiment of Plink, merchant members only compensate the business entity operating Plink when consumer members actually make purchases of items advertised online that the consumer members view, each merchant member can more easily justify registering with Plink. Further, each merchant member can much more easily budget for Plink advertising since Plink may be compensated by a percentage of each consumer member rewards qualifying purchase at the merchant member. In particular, such an embodiment of Plink can be considered a pay-for-performance online advertising system and method.

The Plink advertising system may be used to entice consumer members to frequent Plink member merchant locations such as restaurants, supermarkets, convenience stores and big-box retailers (e.g., Macys®, Home Depot®, Sears®, etc.), theatres, sporting events, etc. It is believed that the presently disclosed Plink advertising system is particularly suited to merchants (e.g., retail establishments) that generally rely on the following business attributes related to consumer visitations and/or purchases: (i) high consumer traffic volume, (ii) high consumer frequency, (iii) lack of product differentiation, and/or (iv) intense competition. In particular, the Plink advertising system herein is particularly useful to merchants whose businesses are substantially driven by such attributes in that consumer visitation and purchasing behavior may be effectively increased through incentive based advertising as disclosed herein.

Further description of the advantages, benefits and patentable aspects of the present disclosure will become evident from the description hereinbelow and the (any) accompanying drawings. All novel aspects of the disclosure, whether mentioned explicitly in this Summary section or otherwise (e.g., hereinbelow), are considered subject matter for patent protection either singly or in combination with other aspects of this disclosure. Accordingly, such novel aspects disclosed hereinbelow and/or in the (any) drawings that may be omitted from, or less than fully described in, this Summary section are fully incorporated herein by reference into this Summary. In particular, all claims of the Claims section hereinbelow are fully incorporated herein by reference into this Summary section.

### BRIEF DESCRIPTION OF THE DRAWINGS

FIG. 1 shows a high level diagram of the Plink advertising system 204 in an operational context of a network 208 such as the Internet.

### DETAILED DESCRIPTION

### Introductory Remarks.

For the purposes of promoting an understanding of the principles set forth in the present disclosure, reference will now be made to exemplary embodiments. Any alterations and further modifications of the inventive features illustrated herein, and any additional applications of the principles illustrated herein, which would occur to one skilled in the relevant art and having possession of this disclosure, are to be considered within the scope of the invention as described in the claims following this Detailed Description section. The features, functions, and the like described herein are considered to be able to be combined in whole or in part one with another as the claims and/or art may direct, either directly or indirectly, implicitly or explicitly.

Reference throughout this specification to an “embodiment,” an “example” or similar language means that a particular feature, structure, characteristic, or combinations thereof described herein may, but do not necessarily, refer to the same embodiment, to different embodiments, or to embodiments disclosed in one or more of the figures.

Many of the functional units described in this specification have been labeled or identified as modules or computational components, in order to more particularly emphasize their implementation independence. For example, a module may be implemented as a combination of hardware and corresponding software substantially independently from other such modules or computational components.

Modules or computational components (e.g., computational machines, equipment, devices, etc.) may comprise one or more physical or logical blocks of computer instructions which may, for instance, be organized as an object, procedure, or function. Nevertheless, the executable versions of such modules or computational components need not be physically located together, but may comprise disparate instructions stored in different locations which, when joined logically together, comprise higher level modules or computational components for achieving a particular stated purpose.

Moreover, a module, computational component and/or a program of executable code may be a single instruction, or many instructions, and may even be distributed over several different code segments, among different programs, and across several non-transitory memory devices. Similarly, operational data may be identified and illustrated herein for such modules or computational components, and may be embodied in any suitable form and organized within any suitable type of data structure. Such operational data may be collected as a single data set, or may be distributed over different locations including over different non-transient storage devices, and may exist, at least temporarily, merely as electronic signals on a system or network.

The various computational components and/or modules discussed herein may include one or more of a communications network host server or other computing systems including: (i) a machine processor for processing digital data; (ii) a non-transitory memory coupled to the processor for storing digital data; an input digitizer coupled to the processor for inputting digital data; (iii) an application program stored in the memory and accessible by the processor for directing processing of digital data by the processor; (iv) a display device coupled to the processor and memory for displaying information derived from digital data processed by the processor; and (v) a plurality of databases including corresponding database management systems. As those skilled in the art will appreciate, any computers or computational machinery discussed herein may include an operating system (e.g., Windows 7, Windows Vista, NT, 95/98/2000, 0S2; UNIX; Linux; Solaris; MacOS, Snow Leopard; etc.) as well as various conventional support software and drivers typically associated with computers and/or a network of computers. The computers or computational machinery may be in a home or business environment with access to the network. In an exemplary embodiment, access is through the Internet through a commercially-available web-browser software package.

The present disclosure may be described herein in terms of functional block components, screen shots, user interaction, optional selections, various processing steps, and the like. It should be appreciated that such functional blocks may be realized by any number of hardware and/or software components configured to perform the specified functions. Accordingly, embodiments disclosed herein may employ various integrated circuit components, e.g., memory elements, processing elements, logic elements, look-up tables, and the like, which may carry out a variety of functions under the control of one or more microprocessors or other control devices. Similarly, the software elements of the present disclosure may be implemented with any programming or scripting language such as C, C++, Java, COBOL, assembler, PERL, Visual Basic, SQL Stored Procedures, AJAX, extensible markup language (XML), and/or SOAP, with the various algorithms being implemented with any combination of data structures, objects, processes, routines or other programming elements. Further, it should be noted that the present disclosure may employ any number of conventional techniques for data transmission, signaling, data processing, network control, and the like. Still further, embodiments of the claimed invention may detect or prevent breaches in security with a client-side scripting language, such as JavaScript, VBScript or the like.

Additionally, many of the functional units and/or modules herein may be described as being “in communication” or “in operable communication” with other functional units and/or modules. Being “in communication” or “in operable communication” refers to any manner and/or way in which functional units and/or modules, such as, but not limited to, computers, laptop computers, PDAs, modules, network servers, routers, gateways, and other types of hardware and/or software, may be in communication with each other. Some non-limiting examples include: (i) activating or invoking another such functional unit or module, and (ii) sending, and/or receiving data or metadata via: a network, a wireless network, software, instructions, circuitry, phone lines, Internet lines, satellite signals, electric signals, optical signals, electrical and magnetic fields and/or pulses, and/or so forth.

Network communication in accordance with the present disclosure may be accomplished through any suitable communication channels, such as, for example, a telephone network, an extranet, an intranet, Internet, point of interaction device (point of sale device, personal digital assistant, cellular phone, kiosk, etc.), online network communications, wireless communications, local area network (LAN), wide area network (WAN), networked or linked devices and/or the like. Moreover, although the network communications may be implemented with TCP/IP communications protocols, such communications may also be implemented using IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY,

MASTERING HTML 4.0 (1997); and LOSHIN, TCP/IP CLEARLY EXPLAINED (1997), the contents of which are hereby incorporated by reference.

For the computational instructions (e.g., software, scripts, firmware, etc.) and/or associated data disclosed or required due to the functional units or modules described herein, it is within the scope of the present disclosure to explicitly include storage media for storing such instructions and/or data. For example, such storage media may be: computer readable magnetic disks or tape, optical disks, and other non-volatile transportable memory (e.g., USB memory sticks, etc.).

As used herein, “comprising,” “including,” “containing,” “is,” “are,” “characterized by,” and grammatical equivalents thereof are inclusive or open-ended terms that do not exclude additional unrecited elements or method steps unless explicitly stated otherwise. “Comprising” is to be interpreted as including the more restrictive terms “consisting of” and “consisting essentially of.”

Prior to the present Plink advertising system, coupons were a merchant's (e.g., retailer's) most widely used incentive based method of driving traffic/visitations to his/her establishment(s). Unfortunately, a direct discount on a merchant's product is detrimental to the profitability of the merchant, and may also negatively impact the consumer's perception of the brand product being discounted. However, the currency/rewards provided by the present Plink advertising system can provide consumers with the motivation needed to change their purchasing behavior without out lowering the value of a merchant member's product such as via a direct discount (e.g., $5.00 off). In particular, such a consumer member after purchase benefit may be viewed as a “gift with purchase”, and such benefits are believed to substantially increase consumer loyalty to Plink merchant members. Accordingly, the present Plink advertising system allows member merchants to compete in crowded vertical markets while differentiating themselves, and thereby increasing market share while maintaining profitability.

Additionally, Plink's pay-for-performance advertising system offers a no-risk value proposition for the member merchants. While pay-for-performance marketing has been used by on-line retailers for many years, it has not been adopted for use in off-line commerce. In exchange for a share of the revenue received by merchant members from off-line consumer member purchases, Plink purchases on-line advertising, registers or signs-up consumer members, tracks their behavior and rewards the consumer members with their choice of rewards, and in particular, such rewards may be a virtual currency that can be utilized at various websites. Accordingly, for each consumer member transaction card purchase at a Plink merchant member (e.g., having corresponding Plink advertising activated by the consumer member), the corresponding purchase information received by the Plink advertising system identifies the following data items:
(1-a) the merchant member,
(1-b) the location of the transaction,
(1-c) the consumer member performing (or responsible for) the transaction, e.g., the name provided on the transaction card,
(1-d) the date (and/or time) of the transaction,
(1-e) the transaction amount,
(1-f) the type of transaction card used for the transaction, and
(1-g) a description of the transaction performed.
   Thus, upon the Plink advertising system receiving such transaction information corresponding to a consumer member purchase, processing is performed by (Plink) computational equipment for determining whether any (or one or more) reward criteria are satisfied so that the consumer member may receive a reward at the Plink website. Moreover, such rewards can be automatically accumulated in Plink accounts of consumer members only after they make their merchant member qualifying purchases.

In one embodiment, the presently disclosed Plink advertising system may provide for varying degrees of complexity in the criteria that can be used for determining whether and/or what rewards a consumer member can obtain. In one embodiment, such criteria may only identify:
(2-a) a date range (e.g., a date before and/or after) in which the item must be purchased, and
(2-b) a member merchant from which the purchase must be made.
   Additionally, such criteria may be expanded to include one or more of the following:
(2-c) a minimum purchase amount,
(2-d) an item for purchase
(2-e) conditions related to the quantity of the item purchased,
(2-f) conditions related to the day of the week of the purchase,
(2-g) conditions related to the time of day of the purchase,
(2-h) conditions related to demographic characteristics of the consumer member performing the purchase (or identified with the transaction card for the purchase),
(2-i) conditions related to the location of the purchase (e.g., a Whole Food Market at a particular location),
(2-j) conditions related to a history of the consumer member's purchases at one or more merchant members (e.g., a frequency of purchases, a total dollar amount of purchases within a given time period, the type of past purchases that qualified for Plink rewards, the total Plink rewards obtained within a given time period, etc.),
(2-k) conditions related to a particular sequence of purchases (e.g., purchase of a restaurant dinner followed within 4 hours by a purchase of theatre tickets),
(2-l) conditions related to a purchase at a particular location (e.g., a particular merchant member's location), or within a particular geographical area (e.g., within a particular shopping mall, within a metropolitan downtown area, within 2 miles of a particular hotel, etc.).

For example, the following conditional rewards rule may be entered into Plink and evaluated thereby for determining whether a Plink consumer member's purchase results in a Plink reward(s) being provided to the consumer member (note, the words “AND”, “OR”, “NOT” have their typical Boolean meanings, and “IN” and “WITHIN” identifies a geographical location/area in the following IF THEN statement):
IF ([(the transaction is for at least two entrees at one of the following merchant members: M₁, M₂, M₃, . . . , Mₙ) OR (the transaction is for one entree at the location of member merchant Mᵢ)] AND
   [the total amount is at least $20] AND
   [the transaction occurred WITHIN 15 miles of the consumer member's residence] AND
   [the transaction is between Jun. 1, 2011 and Aug. 1, 2011] AND
   [the time of the transaction is between 5 pm and 7 pm on one of a Monday or Tuesday] AND
   [(the consumer member is older than 55 years) OR (it is the consumer member's birthday)] AND
   [the transaction card for the purchase is one of: VISA® or MasterCard®] AND
   [the consumer member has made at least a total of $500 in purchases from merchant members in the previous month] AND
   [the consumer member has made purchases with the merchant member of the current purchase at least twice previously in the past month] AND
   [the consumer member also purchased movie tickets (from a merchant member) within 4 hours of the time of the current purchase])
THEN {
   Retrieve a characterization of the rewards to be awarded to the consumer member (e.g., one or more of: an amount of Plink currency that is convertible into currencies acceptable at one or more third party websites, a currency for a particular website operator, e.g., Facebook, a free software download of a particular software product, and/or an amount of Plink currency that may be provided to another consumer member or prospective member, etc.);
   Retrieve a characterization (if any) of how the consumer member desires the rewards to be allocated (e.g., 50% to him/herself in Plink currency, 25% to another consumer member in Facebook currency, and 25% to a charity of the consumer member's choice);
   Allocate the earned rewards as indicated;}

It is believed that, in general, the criteria for a consumer member receiving rewards will not be as complex as the immediately above IF THEN statement. However, it is within the scope of embodiments of the present Plink advertising system to support even more complex conditional reward determination processes and/or rules. In particular, an embodiment of the present Plink advertising system may include a parser and/or interpreter for a computer program language for allowing such conditional reward programmatic statements to be specified by, e.g., merchant members as well as by Plink personnel. Accordingly, an interface to such a program language interpreter may be provided so that merchant members may define and enter such reward conditional IF THEN rules online (e.g., via the Internet or another interactive communications network). Additionally, the present Plink advertising system may provide predetermined rule sets or templates (e.g., macros) for more easily allowing such conditional reward programmatic statements to be defined. Additionally, computer program (software) modules may be provided that periodically and automatically vary the consumer member rewards (e.g., increases the rewards at particularly important and/or competitive times such as in the Christmas season).

In one embodiment of the presently disclosed Plink advertising system a consumer member must have viewed an advertisement to be eligible for receiving a reward upon purchasing a corresponding item presented in the advertisement. In one embodiment, such an advertisement may be a video providing instructional information about the item, and/or distinctions between the item and competing products or services.

Furthermore, computer program modules may be provided for implementing a sequence of such conditional reward programmatic statements over time that have been shown to be effective at driving traffic, e.g., commencing advertising and corresponding rewards for purchases at a new merchant member with a high number of rewards for 3 months, then for a next 3 months lowering the rewards for certain purchases and raising the rewards for other purchases. In one embodiment, the raising and/or lowering of rewards may be determined at least partially by the merchant member's excess (or lack thereof) inventory. In one embodiment, after the first 6 months of new merchant member advertising, conditional reward programmatic statements may be added wherein rewards are provided in combination with purchases from other merchant members.

Note that since merchant members are generally prevented from having access to or information about consumer member transactions with other merchant members, merchant members are prevented from entering and utilizing conditional reward programmatic statements that would disincent a consumer member from making a purchase at a competing merchant member. Accordingly, the Plink advertising system may include a module (software) for inspecting Plink entered conditional reward rules for identifying prohibited conditions. Additionally, the Plink advertising system may also include one or more program modules (software) for suggesting rule modifications that historically have performed well and, e.g., may be similar to a conditional reward rule entered by, e.g., a merchant member.

In one embodiment, when a consumer member performs a reward qualifying purchase at a merchant member's location, a notification of the reward may be transmitted to one or more computers or communication devices (e.g., a mobile phone) for the consumer member, e.g., via email or a text message (via, e.g., a short messaging service). Additionally/optionally, upon such a reward qualifying purchase, the consumer member may be immediately notified that another purchase from the same merchant member in, e.g., the next hour may result in an additional reward that would be greater than if the purchase occurs at a later date. In one embodiment, instead of receiving a reward, the consumer member may be given the option of playing a game to win additional rewards.

In one embodiment, the presently disclosed Plink advertising system may be used to both present a consumer member with advertising and concurrently provide rewards. For example, an insurance company may wish to periodically present company advertising to consumer members insured by the company wherein the advertising is pushed to such consumer members for notifying these members that due to their recent safe driving record (e.g., driving record within the most recent 3 months), they are being allocated rewards from the presently disclosed Plink advertising system.

Moreover, in the event that a consumer member returns a purchase to a merchant member or there is an illicit use of the transaction card at a merchant member (e.g., by an imposter), any corresponding unused rewards derived therefrom may be debited or removed from the consumer member's Plink account.

In one Plink embodiment, consumer members are required, when viewing Plink advertisements, to select the offers in which they are interested for actually completing an (offline) purchase. A consumer member may only be allowed to activate a limited number of merchant member advertisements at any one time (or within a predetermined time period) to ensure repeat consumer member participation with and visitations to a website presenting Plink advertising.

In one Plink embodiment, once a Plink advertisement is selected by a consumer member, and a corresponding merchant member purchase is completed, the advertisement may be prevented from being presented to the consumer member for at least some period of time (and/or, e.g., until after a predetermined number of other reward qualifying purchases at merchant members, or after a predetermined total amount of other reward qualifying purchases at merchant members, or some other condition(s)).

In one Plink embodiment, a Plink advertising website may provide users with access to various online interactive games. In particular, such online games may allow consumer members to proceed through the game (or levels thereof) and unlock or activate additional portions of the game, wherein additional Plink advertising incentives are presented to the game playing consumer member. In addition, bonus incentive offers may be provided by advertising presentations (in the game or otherwise), which may include extra incentives for: (i) purchasing a Plink advertised item at, e.g., a particular time (such as purchasing a dinner at a merchant member's restaurant on a Monday), (ii) for referring other consumers which register with Plink, and/or (iii) for frequency of making rewards qualifying purchases. Note that such bonus incentive offers may be presented to a consumer member in an area of the user's computer display (or Internet browser display window or frame), when additional advertising is presented requiring a consumer member to respond in a different manner from making offline purchases. For example, the consumer member may be required to watch a merchant member sponsored online video in order to gain an additional reward.

Furthermore, in one embodiment, an embodiment of a Plink advertising system may be configured to operate as a multi-level marketing scheme, wherein for each referral that results in a new consumer member, the referring consumer member obtains rewards, at least in part, due to the reward qualifying purchases made by the new consumer member. Note that a referral may be credited to a consumer member wherein there is an activation of a hyperlink by a consumer (that is not yet a consumer member), wherein the hyperlink resides on a website or webpage (e.g., a Facebook page) associated with the consumer member. Accordingly, it is aspect of the Plink advertising system to identify hyperlinks to its website(s) and appropriately associate such hyperlinks with consumer members so that rewards can be dispensed for referrals.

In one embodiment, the Plink advertising system may be provided to a website that facilitates online users interacting with one another substantially about a particular topic, issue, organization, etc. For example, the website may be for a particular private school, wherein students and parents may become Plink consumer members for this website. Accordingly, consumer member qualified rewards may be donated to the private school.

In one embodiment, Plink obtains information identifying from which website a potential consumer member contacted a Plink website (e.g., the Plink website having at least Plink generated advertising thereon for Plink membership). Such website identifying information may be used by Plink to generate Plink consumer membership registration enticements identifying, e.g., a reward such as a virtual currency applicable to the website from which the potential consumer member contacted the Plink website. For example, if the potential consumer member contacts the Plink website from Facebook, then advertising for Plink consumer membership for presentation to the potential member may include information identifying Facebook virtual currency as an incentive for registering as a consumer member, and/or travelling to a merchant member's store and purchasing items at the merchant member's store. Note that Plink may determine information related to which Internet site a person has navigated from for viewing Plink advertising, and use such information for generating advertising to be presented to the person.

Moreover, by locating (potential) consumer member via Internet analysis techniques such as disclosed in U.S. Pat. No. 6,684,250 by Anderson, et al. filed Apr. 3, 2001, incorporated fully by reference herein, Plink advertising may be presented to the (potential) consumer member, wherein such advertising identifies merchant members that are in a geographical area deemed acceptable for the (potential) consumer member to travel thereto. Note that U.S. Pat. No. 6,684,250 discloses a method and an apparatus that operates to associate a geographic location with a corresponding network (Internet) address of such the (potential) consumer member. In particular, information is captured from, e.g., generic Internet routing data that is provided by substantially all Internet packets, and then such information is processed to identify a plurality of geographic locations that are potentially associated with the network address of the (potential) consumer member. Additionally, a confidence factor is also associated with each such geographic location obtained. An estimated most likely geographic location is selected from the plurality of geographic locations as being a best estimate of a true geographic location of the network address of the (potential) consumer member, where the selection of the estimated geographic location is based upon a degree of confidence-factor weighted agreement within the plurality of geographic locations.

In one embodiment, the Plink advertising system may utilize historical transaction card data obtained from, e.g., tracked consumer member purchases. In particular, the Plink advertising system may create, over time, a large database of consumer member purchasing history that can be used to send highly targeted promotions (e.g., Plink advertising) to such members as well as to predict what types of targeted Plink advertising may be effectively responded to by various consumer members according to, e.g., a similarity in demographics and/or a purchasing history similarity. For example, a pizza chain may want to send such a targeted promotion to any consumer member wherein it is determined that a purchase from one of the pizza chain's competitors has been performed in the past year.

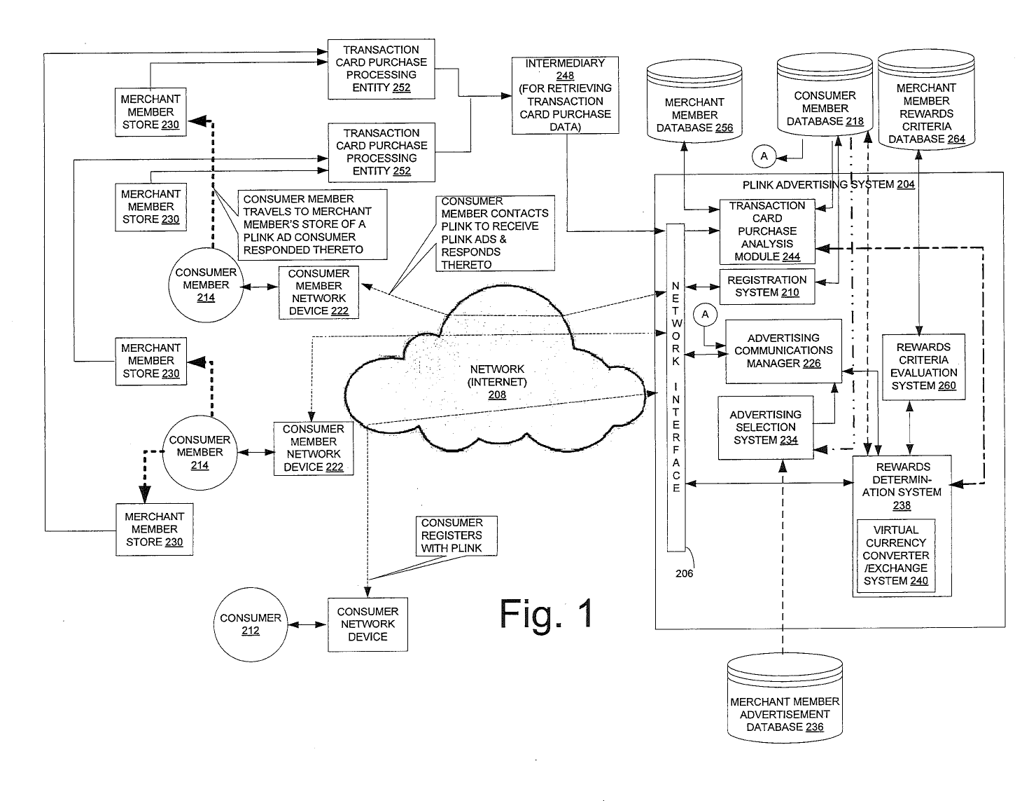

FIG. 1 shows a block diagram of the high level computational machine components of an embodiment of the Plink advertising system. The Plink advertising system 204 shown in this figure includes the following components:
(a) A network interface 206 for interfacing with a network 208 such as the Internet.
(b) A registration system 210 for registering consumers 212 as consumer members 214, wherein consumer information as described hereinabove is obtained from the consumer 212, and stored in the consumer member database 218. In one embodiment, after the registration of a new consumer member 214, the registration system 210 deposits an Internet cookie on the consumer's network device 222 so that when the consumer member 214 subsequently visits the Plink advertising system (website) 204, this system can interrogate the consumer member's cookies for obtaining the consumer member's registration information and thereby automatically identifying the consumer member. In one embodiment, to increase security, in addition to retrieving such a Plink cookie, a browser plug-in or other software component may be activated to identify the consumer's network device 222 prior to providing the consumer member with access to the consumer member functionality of the Plink advertising system 204. In one embodiment, consumer members 214 may access Plink advertising without explicitly contacting the Plink advertising system 204 (or website therefor). For example, if a consumer member 214 (or non-member consumer 212) activates a Plink advertisement presented from a third party (non-Plink operated website) by, e.g., by activating (clicking on) a hyperlink, the registration system 210 may be activated: (i) to retrieve any Plink cookie residing on the consumer member's network device in the case that the consumer is a Plink member so that the Plink advertising system 204 can record the identity of the consumer member 214 as having viewed the Plink advertisement, and to acknowledge to the consumer such recording, (ii) to present a form that allows consumer's register as Plink members or identify themselves as already being Plink members.
(c) An advertising communications manager 226 for communicating advertising related information with the consumer member. In particular, once a consumer member 214 is authenticated (via explicit member entry of his/her identifying information, e.g., username and password, at the time of such authentication, or, via a network 208 transmission of at least a cookie at the time of such authentication), the consumer member then the advertising communications manager 226 provides the following functionality of the Plink advertising system 204:
   (c-i) Network presentations of Plink advertisements to the consumer member 214, wherein such presentations, wherein a response to such an advertisement by the consumer member 214 results in the Plink advertising system 204 storing (in the consumer member database 218) corresponding information indicating that the consumer viewed the advertisement so that the consumer member may receive a reward if the consumer member travels to a store 230 of the merchant member who sponsored the advertisement, and purchases an item at the store that was advertised in the advertisement. Note that such Plink advertising presentations may be determined by the advertising selection system 234 wherein the advertising selection system may:
      (1) retrieve profile information (from the consumer member database 218) on the consumer member 214 for determining one or more Plink advertisements that are deemed to be of likely interest to the consumer member (e.g., sports bar advertising due to such profile information indicating that the consumer member has explicitly input data indicating an interest in receiving sports bar advertising, or due to Plink identifying from transaction card purchases made by the consumer member that he/she frequents sport bars),
      (2) retrieve a collection of one or more merchant member advertisement representations (from the merchant member advertisement database 236) that are currently identified as candidates for presentation, and
      (3) select one or more such advertisement representations for transmitting to the consumer member.

Note that the advertising selection process may be as simple as selecting a least recently presented Plink advertisement that is consistent with the consumer member's sex, age, and geographical location. Alternatively/additionally, the advertising selection process may be based on a frequency or number presentations of various Plink advertisements, on more detailed information regarding the consumer member's interests (e.g., the sports bar example above), or on particular dates of interest to the consumer member (e.g., a spouse's birthday) as provided in an electronic personal calendar.

In one embodiment, weights may be provided to various personal characteristics of the consumer member's profile indicating the consumer member's likely interest in advertising related to such personal characteristics, and/or merchant weights may be also associated with Plink advertisements for such profile characteristics of consumer members, wherein the merchant member sponsoring such a Plink advertisement provides the merchant weights for identifying the relative importances (to the merchant) of particular consumer member personal characteristics. In one embodiment, for each of the consumer member's personal characteristics, its personal weight is multiplied by a corresponding merchant weight for a Plink advertisement, and then all such resulting multiplicative products for the advertisement are summed together. Subsequently (assuming for each personal and merchant weight an increased profile characteristic importance is identified by a non-decreasing weight), the Plink advertisement(s) selected to transmit to the consumer member 214 is the advertisement(s) with the highest sum of the weight products.

In one embodiment, the advertising communication manager 226 may activate the rewards determination system 238 (further described hereinbelow) for determining what types of incentive rewards should be offered to the consumer member 214 as an incentive for purchasing an item advertised in a Plink advertisement. For example, rewards may be offered in various forms, including particular items (e.g., a gift card, a box of jams, clothing, etc.) shipped to consumer members 214, and/or amounts in one or more virtual currencies issued by website operators such as Facebook, Commisson Junction, SponsorPay, Kwedit, gWallet, Sometrics, and TrialPlay. In determining the type(s) of incentive rewards to be presented to consumer member 214 (e.g., with a Plink advertisement), the advertising communication manager 226 may retrieve (from the consumer member database 218) information on the consumer member's preference(s) for rewards. For example, if a consumer member 214 has specified, e.g., that 50% of his/her rewards are to be in Facebook's virtual currency and 50% in SponsorPay's virtual currency, then in generating a Plink advertisement for presentation to the consumer member 214, the advertising communication manager 226 may customize the advertisement to the consumer member so that the incentive reward is presented as 50% of the reward's value in Facebook's virtual currency, and 50% of the reward's value in SponorPay's virtual currency. Alternatively/optionally, a default or generic virtual currency value (as an item purchasing incentive) may be presented with the Plink advertisement together with options for converting such a default or generic virtual currency into another virtual currency. Such a default or generic virtual currency may be specific to the Plink advertising system 204 or may be a virtual currency offered by another website operator such as those identified hereinabove. Note that the functionality for determining a value of a reward in various virtual currencies may be provided by the virtual currency/exchange system 240. In particular, the virtual currency/exchange system 240 may derive or obtain virtual currency exchange rates from such a virtual currency monitoring websites such as www.gameusd.com, and www.whatmmorpg.com. Alternatively/optionally, the virtual currency/exchange system 240 may combine (e.g., average) virtual currency exchange rates from a plurality of virtual currency exchanges, and such combining may weight the various exchange rates according to, e.g., website traffic or another measurement that may be indicative of the relative popularity of such virtual currency exchange rate sites.
(c-ii) Network 208 communications with consumer members 214 that provide responses to Plink advertisements presented. Such communications may provide confirmation to the consumer member that there are potential rewards pending that the consumer member can obtain by purchasing an advertised item upon traveling to a store 226 of the merchant member who sponsored the Plink advertisement, and purchasing an advertised item. Additionally/alternatively, such communications may inform a consumer member 214 of additional rewards that may be available such as upon traveling to a store 226 of the merchant member who sponsored the Plink advertisement, and purchasing an item at the store that was advertised in the advertisement, if the consumer member also purchases another item, then the consumer member's corresponding rewards will be substantially increased.
(c-iii) Network presentations providing the consumer member 214 with information about the rewards the consumer has obtained. Such presentations may be provided by activation of the rewards determination system 238 (described further hereinbelow), wherein this system 238 may query the consumer member database 218 with the consumer member's Plink identification for retrieving the consumer's information about the rewards the consumer has obtained. Additionally, the rewards determination system 238 may be activated by the consumer member directly for, e.g., assigning his/her rewards to a charity, spouse, etc.
(d) A transaction card purchase analysis module 244 for analyzing consumer member 214 purchases performed with one or more transaction cards that the consumer member has identified and authorized the Plink advertising system 204 to track the purchases performed with such transaction cards. Accordingly, the module 244 receives information regarding transaction card purchases from an intermediary 248 (well known in the art) that pulls transaction card purchasing information from one or more transaction card purchasing processing entities 252 (FIG. 1), wherein each such processing entity 252 processes transaction card purchases made with one or more types of transaction cards. For example, one processing entity 252 may process purchases made with VISA® credit or debit cards so that payments are made to the sellers for the purchases, and corresponding charges are applied to accounts of consumers responsible for payment of such purchases. Thus, as indicated in FIG. 1, when a consumer uses a particular transaction card to pay for a purchase, the seller (e.g., a merchant member store 230 in FIG. 1) transmits corresponding transaction card purchasing information (e.g., the data identified in (1-a) through (1-g) of the Summary section hereinabove) to one of the processing entities 252 to process the payment for the purchase, and after such a purchase is processed, the intermediary 248 is able to identify and access the transaction card purchasing information for, in turn, transmitting it to module 244 of the Plink advertising system 204.

In one embodiment, the transaction card purchase analysis module 244 receives transaction card purchasing information for each consumer member purchase performed with a transaction card that Plink has authorization to track. In particular, the data identified in (1-a) through (1-g) of the Summary section hereinabove may be provided to the module 244 by the intermediary 248. Upon receiving such transaction card purchase data, module 244 at a high level determines that the purchase can be tracked, determines the merchant member from which the purchase was performed, records that the purchase was made at the merchant member's physical store, determines (any) rewards to be allotted to the consumer member due to the purchase, and optionally, notifies the consumer member of his/her rewards and/or additional rewards that can be obtained for performing additional purchases. In one embodiment, upon receiving such transaction card purchase data for a particular purchase, the module 244 may perform steps corresponding to the following high level pseudo-code (wherein “←” represents an assignment computer program operator):

Transaction_Card_Purchase_Analysis_Module( )
{

| Purchase_data ← Receive the transaction card purchase data from the intermediary | |
|---|---|
| | 248 for a consumer member 214 purchase; |
| Consumer_member ← Extract from the Purchase_data the transaction card type | |
| | and the consumer member name on the transaction card for accessing the |
| | consumer member database 218 and retrieving data identifying the |
| | consumer member that performed the purchase; |
| IF (Consumer_member cannot be found in the consumer member database 218) | |
| | OR (Plink does not currently have authorization to track the transaction |
| | card) THEN terminate Purchase_data processing; |
| ELSE /* Consumer_member was found & tracking is authorized */ | |
| { | Determine whether the purchase for the Purchase_data is from a Plink |

| | merchant member; |
|---|---|
| IF not, THEN | |
| { | IF (consumer member 214 identified in Consumer_member consented |

to being tracked for non-merchant member purchases) THEN

Enter the Purchase_data in the consumer member database 218,
wherein this data is associated with this consumer member;

terminate Purchase_data processing;

}
ELSE /* the purchase was made from a Plink merchant member & tracking

is authorized */

| | |
|---|---|
| { | Enter the Purchase_data in the consumer member database 218, |

wherein this data is associated with this consumer member;
Record the consumer member's purchase in the Merchant Member

| Database 256 (Fig. 1), wherein this database identifies each of | |
|---|---|
| the merchant members 230, and for each of these merchant | |
| members, the following data may be stored in this database: | |
| (i) | The number consumer member 214 visits to the |
| | merchant member's store(s) 230 that resulted in a |
| | purchase resulting from Plink advertisement |
| | previously presented to the consumer members; |
| (ii) | The merchant member physical store identification(s), |
| | e.g., physical address location(s), and merchant |
| | member store identification(s) internal to the merchant |
| | member; |
| (iii) | Information about purchases by consumer members |
| | 214, e.g., ratio of consumer member 214 purchases to |
| | the number of the merchant member's |
| | advertisement(s) presented to consumer members, the |
| | dollar amounts for average purchase (e.g., per month, |
| | year, etc.), the dollar amount for the total consumer |
| | member purchases (e.g., per month, year, etc.), such |
| | ratios or total dollar amounts per merchant member |
| | physical store; |
| (iv) | Information regarding consumer members who |

perform the purchases, e.g., distances consumer
members 214 travel to perform their purchases,
geographical areas from which consumer members
travel to perform their purchases, etc.

Rewards ← Activate the rewards determination system 238 for

determining (any) rewards due to the consumer member
for the purchase(s) made that include the purchase(s)
corresponding to Purchase_data;

Optionally, notify the consumer member of the newly (if any) allocated

rewards to him/her, e.g., via email, or a short messaging
service (SMS), etc. Such notification may be substantially
immediately after the purchase via, e.g., SMS;

Optionally, notify the consumer member of additional rewards that can

be obtained by purchasing additional items while the
consumer member is: (i) at the merchant member's store
230, (ii) within an area (e.g., within 2 miles or within the
same shopping mall) of another merchant member's store
230, and/or (iii) on a route the consumer member is likely
to travel;

| | | |
|---|---|---|
| } | } | } // END Transaction_Card_Purchase_Analysis_Module |

(e) The rewards determination system 238 determines reward incentives to be presented to consumer members 214 wherein, e.g., when such a consumer views a Plink merchant's advertisement, travels to the merchant's store 230 (the merchant sponsoring the advertisement), and purchases an item presented in the Plink advertisement, the reward is provided/allocated to the consumer. Providing virtual currencies as rewards is an important feature of the present disclosure in that there may be efficiencies derived from using such currencies since, e.g., there may be reduced or no transaction fees as can occur with credit or debit card charges. In one embodiment, the rewards determination system 238 may determine what consumer member's reward incentive should be depending on whether the consumer member consented to (or specified) one or more virtual currencies for at least a portion of his/her rewards as described in (c-i) hereinabove. Thus, if a consumer member 214 has specified that 50% of his/her rewards are to be in Facebook's virtual currency and 50% in SponsorPay's virtual currency, in generating a Plink advertisement for presentation to the consumer member 214, the advertisement may be customized to the consumer member so that the reward the consumer member can obtain corresponds with what the consumer has requested.

Pseudo-code for a high level embodiment of the rewards determination system 238 is provided hereinbelow. Note, it is assumed for ease of presentation in this pseudo-code that consumer member reward incentives are represented in a single generic currency such as Facebook® virtual currency, or any other currency, including in one embodiment, actual U.S. dollars; however, it is within the scope of the present disclosure that for different consumer members 214, such rewards could be in different currencies and/or may specify particular items that could be, e.g., shipped to the consumer member. In the pseudo-code that follows, the terms Consumer_member and Purchase_data are as described above.

Rewards_Determination_System(Consumer_member, Purchase_data)
{
Merchant ← Identify the merchant member 214 to which the Consumer_member

travelled and performed the purchase;

Items_Purchased ← Identify the one or more items purchased by the Consumer_member;
Ads_list ← Retrieve from the consumer member database 218 the list of one or more

advertisements to which the Consumer_member has responded
wherein these advertisements may have rewards associated with a
purchase from the Merchant;

Total_Rewards_Due ← 0; /* Initialization */

FOR EACH (AD on Ads_list) DO {

New_Rewards ← Activate the rewards criteria evaluation system 260 (Fig. 1,

and described hereinbelow) for obtaining (any) new rewards due to the
Consumer_member travelling to the Merchant's store 230 and
purchasing from the Merchant one or more of the items identified on the
Items_Purchased list;

Total_Rewards_Due ← Total_Rewards_Due + New_Rewards;

}
IF (Total_Rewards_Due is NOT zero) THEN {

Rewards_allocation ← Retrieve any allocation of rewards that the

Consumer_member has specified from the consumer member
database 218; /* note that (c-iii) above describes various
embodiments of reward allocations */

IF (Rewards_allocation is non-empty) THEN {

```
/* allocate rewards, e.g., for services (e.g., games) at one or more
  websites, to other consumer members 214, to friends or family
  members, or to a charity, etc. */
Allocate the Total_Rewards_Due as provided in Rewards_allocation;
```

ELSE /* no Consumer_member specific allocation of rewards has been

provided */
Record in the consumer member database 218 that the

Consumer_member has Total_Rewards_Due additional rewards;

### } //END Rewards_Determination_System

The rewards criteria evaluation system 260, at a high level, may be embodied by the following pseudo-code, wherein Consumer_member, Merchant, AD, and Items_Purchased are as described above, and this pseudo-code returns the rewards due to the Consumer_member travelling to the Merchant's store 230 and purchasing one or more of the items identified in Items_Purchased.

Rewards_Criteria_Evaluation_System(Consumer_member, Merchant, AD,

Items_Purchased)

{

Total_Rewards_Due ← 0; /* Initialization */
Rewards_criteria ← Retrieve from the merchant member rewards criteria

database 264 (Fig. 1) the (any) list of one or more reward conditions
associated with AD, wherein each condition includes a pair: (Condition,
Reward) such that Condition identifies a Consumer_member purchase
event which if satisfied, results in the Reward being allocated to the
Consumer_member. The Condition may include one or more of the
following: (1) an item(s) description that must be purchased to obtain the
Reward, (2) a number of such items purchased to obtain the Reward, (3)
a time/date range for the purchase to obtain the Reward, (4) a geographic
location (Merchant store address) for the purchase to obtain the Reward,
historical information regarding the Consumer_member's purchases with
the Merchant (e.g., a time range for a previous history of such purchases,
a dollar amount of such previous purchases, etc.) as well as other
conditions such as those identified in (2-a) through (2-l) hereinabove
and/or identified in the example following the conditions (2-a) through
(2-l);

FOR EACH (pair Conditionᵢ, Rewardᵢ) pair in Rewards_criteria) DO

IF (Conditionᵢ is satisfied by the items identified on the list

Items_Purchased) THEN
Total_Rewards_Due ← Total_Rewards_Due + Rewardsᵢ;

RETURN(Total_Rewards_Due);

} //END Rewards_Criteria_Evaluation_System

(f)

Accordingly, it is an aspect of the presently disclosed Plink advertising system to give merchant members a no-risk form of advertising while providing Plink a consistent revenue stream and valuable purchasing information about consumer members.

The present disclosure has been presented for purposes of illustration and description. Further, the description herein is not intended to limit the present disclosure to the form disclosed herein. In particular, variation and modification commiserate with the above teachings, within the skill and knowledge of those having ordinary skill in the relevant art, are within the scope of the present disclosure. The present disclosure is further intended to explain the best mode presently known of practicing the invention as recited in the claims, and to enable others skilled in the art to utilize the present disclosure, or other embodiments derived therefrom, e.g., with the various modifications required by their particular application or uses of the present disclosure.

What is claimed is:

1. A method of advertising on a communications network, comprising performing the following steps by computational equipment:
receiving a network request from a user for registering information for identifying the user and a transaction card therefor;
transmitting, via the network, advertising data for presenting an advertisement to the user via a user device for receiving the advertising data, the advertisement identifying a merchant, and an item advertised in the advertisement;
first receiving, via the network, a first transmission indicative of the user responding to the advertisement;
storing a information indicative of the user's response to the advertisement;
second receiving, via the network, a second transmission indicative of a purchase of the item by the user, wherein payment for the purchase identifies the transaction card;
wherein data for the second transmission is obtained from a data storage that includes data indicative of purchases by a plurality of users at a plurality of merchants, at least most of the merchants operating independently from the merchant;
determining, from data of the second transmission, that the purchase occurred at a physical location for the merchant wherein the user physically travelled to the location for performing the purchase; and
generating data indicative of a reward corresponding to the user responding to the advertisement and travelling to the location and purchasing the item, wherein the reward is provided to the user or an entity identified by the user.
